(19) United States
(12) Patent Application Publication
(10) Pub. No.: US 2006/0179038 A1
(43) Pub. Date: Aug. 10, 2006

(54) Presenting FAQ's during a task of entering an e-mail message

(75) Inventors: Gregory W. Edwards, Austin, TX (US); George Dante M. Pineda, Elbum, FL (US); Kevin L. Farmer, Saginaw, MI (US); Kenneth P. Laswell, Florissan, MO (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/051,551

(22) Filed: Feb. 4, 2005

(51) Int. Cl. G06F 17/30

(52) U.S. Cl. 707/3

(57) ABSTRACT

During a task of composing an e-mail which comprises a message, a display page having one or more previously-asked questions relevant to the message is outputted to a user. The previously-asked questions may be included in the display page upon determining that a predicted performance of search results found by a search system from a previously-asked questions database for the message is acceptable. The predicted performance is based on parameters determined from an analysis of a performance of the search system for a sample of e-mails received.

### FIELD OF THE DISCLOSURE

The present disclosure relates to methods and systems for providing previously-asked questions and answers.

### BACKGROUND

As Web sites become more popular for consumers to research and buy products and services, a number of support and information-querying e-mails to companies is also increasing. This results in increased customer support demands on companies and may create slower response times to their customers. Some Web sites, in response to receiving an e-mail message, create an automatic e-mail response that contains answers to one or more frequently-asked questions (FAQs).

### BRIEF DESCRIPTION OF THE DRAWINGS

The present invention is pointed out with particularity in the appended claims. However, other features are described in the following detailed description in conjunction with the accompanying drawings in which:

FIG. 1 is a flow chart of an embodiment of a method of providing relevant previously asked questions while a user is filling in an e-mail form;

FIG. 2 is a block diagram of an embodiment of a system for providing relevant previously asked questions while the user is filling in the e-mail form;

FIG. 3 is a screen shot of an embodiment of a first page of the e-mail form; and

FIG. 4 is a screen shot of an embodiment of a second page of the e-mail form.

### DETAILED DESCRIPTION OF THE DRAWINGS

Disclosed herein are embodiments of presenting relevant previously asked questions and answers while a user is filling in an e-mail form. This reduces a number of e-mails to which a company must respond while still providing useful and timely information to its customers.

In one embodiment, during a task of composing an e-mail which comprises a message, a display page having one or more previously-asked questions relevant to the message is outputted for display to a user.

By following the procedure disclosed herein, companies with a Web site, e-mail system and natural language search engine can significantly reduce incoming e-mail while simultaneously increasing customer satisfaction.

Embodiment are described with reference to FIGS. I and 2 which are a flow chart of an embodiment of a method and a block diagram of an embodiment of a system, respectively, of providing relevant previously asked questions while a user is filling in an e-mail form.

As indicated by block 10, the method comprises performing a preliminary analysis of existing e-mails 12 sent to a party. The party may be an individual, a company or another type of organization. The preliminary analysis determines one or more statistics 14 of lengths of the existing e-mails 12. In one embodiment, the statics 14 comprise an average number of sentences in the existing e-mails 12. Examples of the average include, but are not limited to, a sample mean, a sample median, and a sample mode. The preliminary analysis also identifies the most popular topics 16 of the existing e-mails 12. The preliminary analysis is performed by a preliminary analyzer 20, which comprises a computer in one embodiment. The preliminary analyzer 20 may comprise a spreadsheet macro or other computer program code to determine the average number of sentences.

As indicated by block 22, the method comprises performing an analysis of a performance of a natural language search system 24 for a sample of e-mails 26. For each e-mail in the sample of e-mails 26, the natural language search system 24 performs a natural language search of a frequently-asked question (FAQ) database 30 based on content in the e-mail. The natural language search system 24 generates FAQ search results 32 for each e-mail in the sample of e-mails 26.

The second analysis establishes how well the natural language search system 24 performs in returning relevant FAQs for the sample of e-mails 26. In one embodiment, the second analysis determines, for each e-mail in the sample 26, how well relevancy rankings of the FAQ search results 32 match the relevancy of the content of the e-mail. This determination is performed by one or more subject matter experts (SMEs) 34. For each e-mail from the sample 26, one or more of the SMEs 34 evaluates the associated FAQ search results 32 returned from the natural language search engine 24 for relevancy. Each evaluation of relevancy may be on a discrete scale, such as a scale from one to three. The SMEs 34 return relevancy evaluations 36 for the FAQ search results 32 returned for the sample of e-mails 26. In one embodiment, each e-mail in the sample 26 and its response are analyzed by at least three of the SMEs 34. For each e-mail in the sample 26, an average score can be determined by averaging its relevancy evaluations from a plurality of the SMEs 34.

In one embodiment, those of the existing e-mails 12 having the most popular topics 16 and most likely lengths based on the one or more statistics 14 are selected to be included in the sample of e-mails 26. The sample of e-mails 26 are selected by a filter 38 based on the statistic(s) 14 and the popular topics 16. In this case, the second analysis establishes how well the natural language search system 24 responds to a representative sample of the most popular e-mail topics and lengths, and how well its relevancy ranking matches a true relevancy of the responses.

Optionally, the method comprises performing an exercise 40 before the second analysis. The exercise is performed using an exercise component 41 to reduce variability in how different SMEs 34 evaluate and score relevancy. The exercise may involve providing instructions and examples of how the SMEs 34 should evaluate relevancy. The exercise may also include determining inter-rater reliability.

As indicated by block 42, the method comprises determining parameters 44 of those of the e-mails 26 whose performance is acceptable (i.e. those causing relevancy evaluations 36 that are desirably-high), and/or those of the e-mails 26 whose performance is unacceptable (i.e. those causing relevancy evaluations 36 that are undesirably-low). This act is used to determine if topic, length or system relevancy rankings are related to true SME relevance rankings. For example, the natural language search system 24 may perform unacceptably on e-mails longer than eight sentences, and e-mails asking questions on specific bill charges, and e-mails that create relevancy rankings lower than 50% from the engine itself. The cut-off(s) for acceptable and unacceptable are chosen by the party receiving the e-mails.

For example, if the natural language search system 24 returns five FAQs for each e-mail, it is possible that one or more of the five FAQs are not relevant to some e-mails. If at least one of the five FAQs is a perfect match to an e-mail (e.g. rated by the SMEs as a 3 on a scale of 1-3), then the returned FAQs are considered as successfully answering the e-mail and are thereby deemed acceptable. The parameters 44 are determined by determining a number of successfully-answered e-mails (e.g. with at least one FAQ ranked as a 3) based on e-mail length, topic and system relevancy.

As indicated by block 50, the method comprises providing a user interface 52 for users to perform a task of composing e-mail messages to the party. The user interface 52 may comprise one or more electronic pages, e.g. Web pages, accessible via a computer network, e.g. the Internet, an intranet or an extranet.

A usability study may be performed to determine a most desirable design for the user interface 52. The usability study may be performed for multiple users on competing user interface designs to arrive at a most desirable user interface design. A user interface is deemed most desirable based on usability scores, customer rankings and number of errors.

In one embodiment, the user interface 52 comprises a first page 54 which is a message-receiving page. The first page 54 has a portion 60 (e.g. a text box) which accepts as user input a message 62 such as a comment or a question to the party. The first page 54 is outputted to enable a user to type or otherwise input the message 62. The first page 54 further includes a continue control 64 that the user selects to indicate that he/she has completed inputting the message 62.

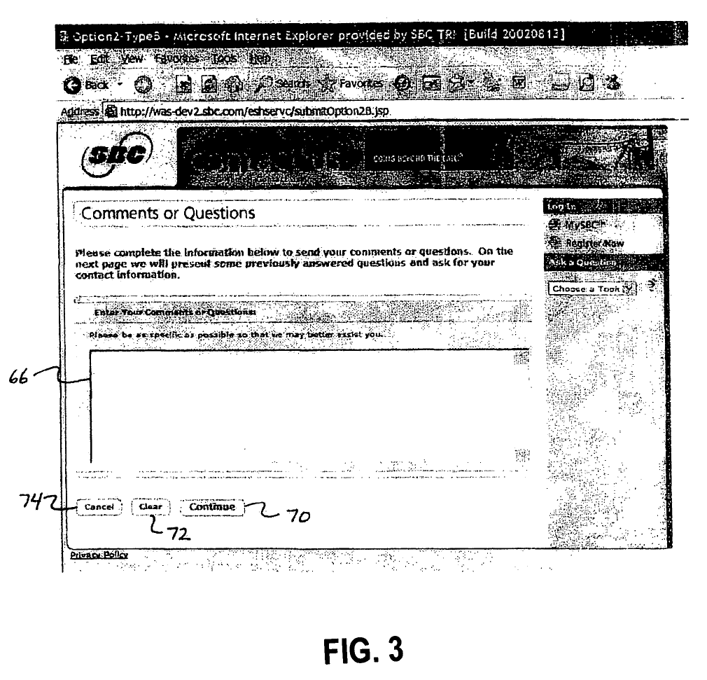

FIG. 3 is a screen shot of an embodiment of the first page 54. The portion 60 is embodied by a text box 66, above, in which an instruction for users to “enter your comments or questions” is displayed. The continue control 64 is embodied by a continue button 70. A clear button 72, when selected by the user, causes any user-entered text in the text box 66 to be cleared. A cancel button 74, when selected by the user, causes an exit from the first page 54 to a different page.

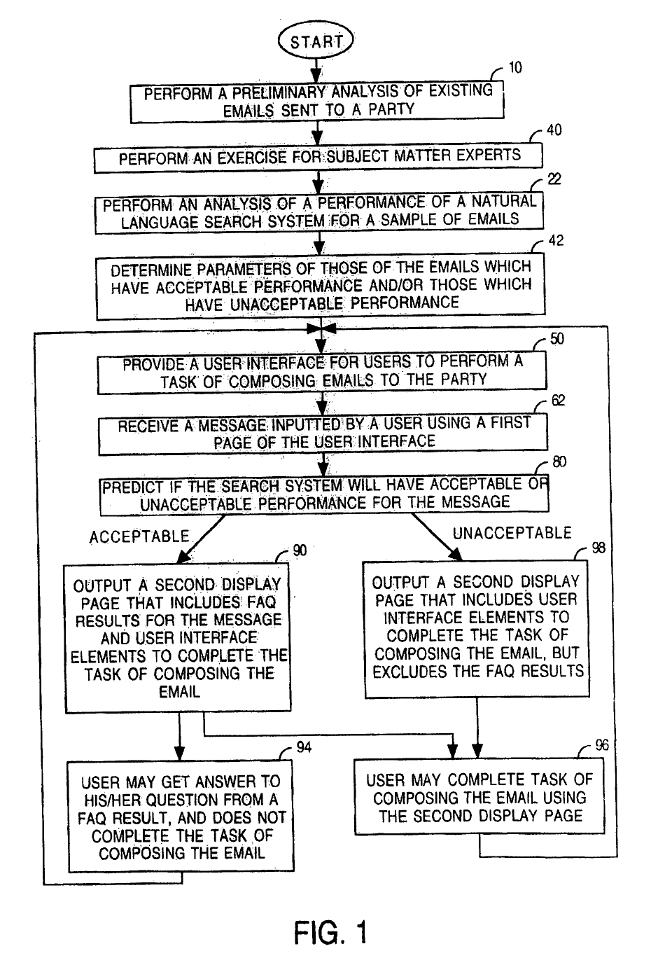

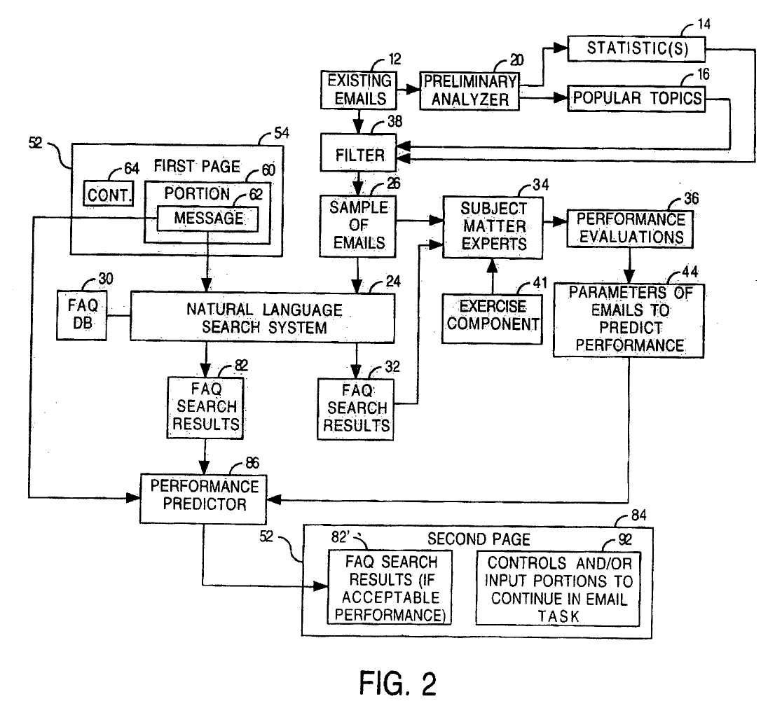

Returning to FIGS. 1 and 2, the method comprises receiving the message 62 inputted by the user. In one embodiment, the message 62 is received in response to a user selection of the continue control 64 such as the continue button 70 in FIG. 3. In other embodiments, the message 62 may be received while being typed or otherwise inputted by the user without use of the continue control 64.

As indicated by block 80, the method comprises determining a predicted performance of search results found by the natural language search system 24 for the message 62. The predicted performance is used to determine if the message 62 will cause an acceptable or an unacceptable result from the natural language search system 24. The predicted performance is determined by a performance predictor component 86 based on the parameters 44 determined in block 42, the length and topic of the message 62, and relevance rankings of FAQ results 82 generated by the natural language search system 24 for the message 62.

If the message 62 is predicted to cause an acceptable result, one or more of the FAQ results 82′ are provided to the user on a second page 84 of the user interface 52 as indicated by block 90. The second page 84 is outputted before the user has finalized the e-mail. In one embodiment, the FAQ results 82′ are displayed at or near the top of the second page 84. The second page 84 also includes a message telling the user to continue filling in his/her personal information if none of the FAQ results 82′ adequately answer a question in the message 62. The second page 84 includes user interface elements 92 (e.g. one or more controls and/or input portions) to complete the task of composing the e-mail. The second page 84 accepts, as user input, personal information to identify a sender of the e-mail, and a command to finalize and send the e-mail.

As indicated by block 94, the user may get an answer to his/her question from one of the FAQ results 82′. In this case, the user need not complete the task of composing the e-mail.

Alternatively, the user may not get an answer to his/her question from one of the FAQ results 82′. In this case, as indicated by block 96, the user may complete the task of composing and sending the e-mail using the second display page 84.

If the message 62 is predicted to cause an unacceptable result, none of the FAQ results 82 are presented on the second page 84, as indicated by block 98. Although the FAQ results are excluded, the second page 84 still includes the user interface elements 92 to complete the task of composing and sending the e-mail. Other instances in which FAQ results are not presented on the second page 84 include messages whose topics are new, messages for which relevant content in the FAQ database 30 does not exist, and messages containing comments that have no direct answer. As indicated by block 96, the user may complete the task of composing and sending the e-mail using the second display page 84.

In this way, the system is tailored to only respond with FAQs to those messages that fit the highest relevancy standards, and to not present FAQs with undesirably low relevancy standards.

If the message 62 comprises a new question, the new question is stored for later use, as indicated by block 94. The new question may be used for possible improvement of the knowledge base at a later time.

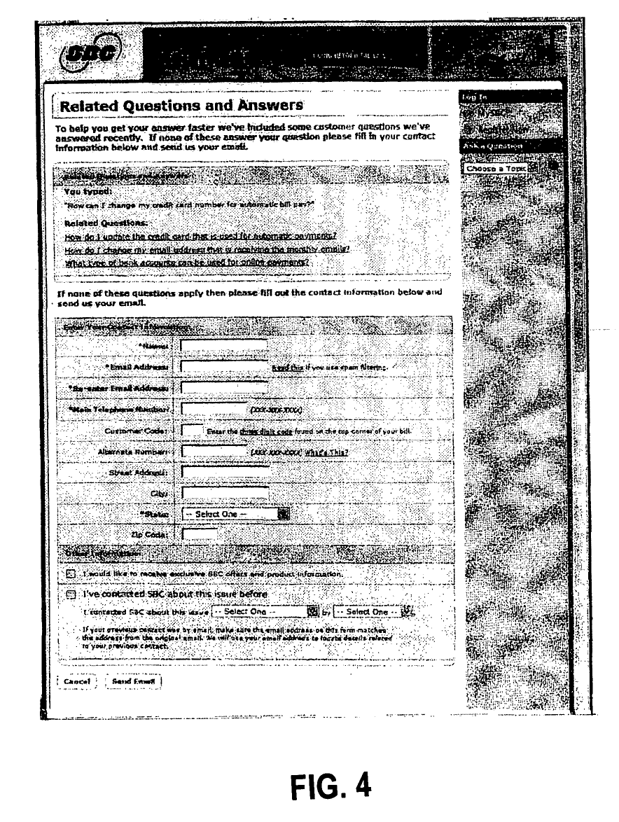

FIG. 4 is a screen shot of an embodiment of the second page 84. In this embodiment, the message 62 entered on the first page 54 by the user is “how can I change my credit card number for automatic bill pay?”. The second page 84 displays three related questions for the message 62: “how do I update the credit card that is used for automatic payments”, “how do I change my e-mail address that is receiving the monthly e-mails”, and “what type of bank accounts can be used for online payments”. Each question is user-selectable to link to a page having the answer thereto.

Below the related questions are fields for the user to enter his/her contact information. The contact information includes a name, an e-mail address, a re-entered e-mail address, a main telephone number, a customer code, an alternative telephone number, a street address, a city, a state and a postal code.

Below the contact information fields is a user-selectable control (e.g. a check box) for a user to indicate that he/she would like to receive exclusive offers and product information provided by the party. Another user-selectable control (e.g. a check box) is for the user to indicate that he/she has previously contacted the party about the same issue.

A send-e-mail control, such as a send-e-mail button, is selected by the user after he/she has entered his/her contact information. After the send-e-mail button is user selected, the message 62 is sent to an appropriate recipient by an e-mail system of the party. Based on the message 62, the recipient can provide an answer or another response within an e-mail to the sender, a telephone call to the sender, a letter to the sender, or a fax to the sender, for example. A cancel control, such as a cancel button 74, when selected by the user causes an exit from the second page 84 to a different page.

Using the teachings herein, FAQs are presented to a customer when he/she is in a task of wanting to send an e-mail to a company. The FAQs are presented only under acceptable relevancy standards, and are otherwise suppressed.

The herein-disclosed components and acts can be implemented using a computer system comprising one or more computers. The computer system may be directed by computer-readable program code stored by a computer-readable medium to provide the components and to perform the acts. The computer system may store the herein-disclosed data on a computer-readable medium.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
during a task of composing an e-mail which comprises a message, outputting a display page having one or more previously-asked questions relevant to the message.

2. The method of claim 1 further comprising:
receiving the message inputted by a user to a message-receiving page;
wherein said outputting the display page is performed before the user has finalized the e-mail.

3. The method of claim 1 further comprising prior to said composing the e-mail:
performing an analysis of a performance of a search system for a sample of e-mails received by the party, the performance being evaluated by one or more subject matter experts; and
determining parameters of those of the e-mails whose performance is acceptable.

4. The method of claim 3 wherein the parameters include a message length, a message topic and a search-system-produced relevancy ranking.

5. The method of claim 3 further comprising:
determining a predicted performance of search results found by the search system from a previously-asked questions database for the message, said determining the predicted performance being based on the parameters; and
determining that the predicted performance is acceptable;
wherein the one or more previously-asked questions in the display page include at least one of the search results based on said determining that the predicted performance is acceptable.

6. The method of claim 3 further comprising prior to said composing the e-mail:
determining one or more popular topics of the e-mails;
determining one or more likely lengths of the e-mails; and
selecting those of the e-mails having the one or more popular topics and one or more likely lengths to be in the sample.

7. The method of claim 1 wherein the display page is usable to continue in the task of composing the e-mail.

8. The method of claim 7 wherein the display page accepts, as user input, personal information to identify a sender of the e-mail.

9. An apparatus comprising:
a computer system that, during a task of composing an e-mail which comprises a message, outputs a display page having one or more previously-asked questions relevant to the message.

10. The apparatus of claim 9 wherein the computer system is to output a message-receiving page and to receive the message inputted by a user to the message-receiving page, wherein the computer system outputs the display page before the user has finalized the e-mail.

11. The apparatus of claim 9 wherein the computer system stores parameters based on an analysis of a performance of a search system for a sample of e-mails received by the party, the performance being evaluated by one or more subject matter experts, wherein the parameters are of those of the e-mails whose performance is acceptable.

12. The apparatus of claim 11 wherein the parameters include a message length, a message topic and a search-system-produced relevancy ranking.

13. The apparatus of claim 11 wherein the computer system is to determine a predicted performance of search results found by the search system from a previously-asked questions database for the message, the predicted performance being based on the parameters, and wherein the computer system is to include at least one of the search results in the one or more previously-asked questions in the display page based on determining that the predicted performance is acceptable.

14. The apparatus of claim 11 wherein the computer system is to:
determine one or more popular topics of the e-mails;
determine one or more likely lengths of the e-mails; and
select those of the e-mails having the one or more popular topics and one or more likely lengths to be in the sample.

15. The apparatus of claim 9 wherein the display page is usable to continue in the task of composing the e-mail.

16. The apparatus of claim 15 wherein the display page accepts, as user input, personal information to identify a sender of the e-mail.

17. A computer-readable medium having computer-readable program code to direct a computer system, during a task of composing an e-mail which comprises a message, to output a display page having one or more previously-asked questions relevant to the message.

18. The computer-readable medium of claim 17 wherein the computer program code causes the computer system to output a message-receiving page and to receive the message inputted by a user to the message-receiving page, wherein the display page is outputted before the user has finalized the e-mail.

19. The computer-readable medium of claim 17 wherein the computer program code causes the computer system to determine a predicted performance of search results found by a search system from a previously-asked questions database for the message, the predicted performance being based on parameters determined based on an analysis of a performance of the search system for a sample of e-mails received by the party, the performance being evaluated by one or more subject matter experts, wherein the parameters are of those of the e-mails whose performance is acceptable, and wherein the computer program code causes the computer system to include at least one of the search results in the one or more previously-asked questions in the display page based on determining that the predicted performance is acceptable.

20. The computer-readable medium of claim 17 wherein the display page is usable to continue in the task of composing the e-mail, and wherein the display page accepts, as user input, personal information to identify a sender of the e-mail.
